(19) United States
(12) Patent Application Publication
(10) Pub. No.: US 2015/0284120 A1
(43) Pub. Date: Oct. 8, 2015

(54) TRAY DISPENSER AND USE THEREOF

(71) Applicant: INTECH INTERNATIONAL A/S, Brønderslev (DK)

(72) Inventor: Carsten Trudslev, Bronderslev (DK)

(73) Assignee: INTECH INTERNATIONAL A/S, Brønderslev (DK)

(21) Appl. No.: 14/433,412

(22) PCT Filed: Sep. 30, 2013
(86) PCT No.: PCT/DK2013/000061

§ 371 Date: Apr. 3, 2015

(30) Foreign Application Priority Data
Nov. 2, 2012 (DK) PA 2012 00685

(51) Int. Cl. B65B 43/44; B65G 59/10

(52) U.S. Cl. CPC B65B 43/44; B65G 59/10

(57) ABSTRACT

The invention relates to a tray dispenser (1) for dispensing of trays for packaging where the tray dispenser includes a tray dispenser cassette (2) and a base station (3) which can be placed on a stand (6) and where the tray dispenser cassette (2) can be connected to the base station. The base station (3) contains electronic components and at least one motor (19) which, via a mechanical coupling (18) can operate the tray dispenser cassette containing mechanical components made only of materials that are corrosion resistant. The cassette (2) is immersed in a cleaning fluid to clean the tray dispenser cassette (2) thoroughly whereby bacterial proliferation and contamination from the tray dispenser cassette (2) can be reduced to a minimum.

### CROSS REFERENCE TO RELATED APPLICATIONS

This application is a national stage of PCT International patent application no. PCT/DK2013/000061, filed 30 Sep. 2013, which claimed priority in Danish patent application no. PA 2012 00685, filed 2 Nov. 2012, the contents of these documents being incorporated herein by reference.

### TECHNICAL FIELD

The invention relates to a tray dispenser for dispensing of trays such as trays for packaging, where the tray dispenser includes a tray dispenser cassette and a base station that can be placed on a stand, and where the tray dispenser cassette can be interconnected with the base station, wherein the base station contains the electronic components and where the tray dispenser cassette, containing solely mechanical components made of materials that are corrosion resistant, can be cleaned by immersion in a cleaning liquid.

Furthermore, the invention relates to the application of the tray dispenser.

### BACKGROUND

It is known that cassette-based tray dispensers are manufactured and used to dispense items such as trays for packaging. The currently known systems contain various valves and rotating cylinders etc. inside the cassette. These can be difficult to clean and usually cannot withstand water and detergents.

This often results in dirt and bacteria accumulating inside the cassette when the premises and adjacent machines are cleaned with water and detergent using high pressure.

During operation, the bacteria are spread to the trays through the exhaust air coming from the valves and cylinders and trays, which set the air in the cassette in motion. Thus, there is a high risk of bacterial contamination. The high humidity that may occur in production plants during cleaning of premises and equipment can form dirt/bacteria for example inside the cassette, which cannot be cleaned. This will cause a potential health risk.

It is also a drawback of the currently know systems that cassettes typically weigh approx. 30 kg. Modern health and safety legislation dictates that one person is allowed to lift no more than 11 kg, which means that one employee cannot handle the cassette alone. Thus, in accordance with modern legislation, more than one person must be present to lift/handle the currently known cassettes which is, however, rarely observed.

Cassettes made according to known principles include components such as cylinders that among other things contain steel, and which are not resistant to water. Due to water penetration and condensation in the components, rust will be formed over time and rusty bacteria-filled water can then leak out and, for example, drip down the trays during dispensing.

The known relevant technology is described in the following documents:

(D1) WO 2005i044703 A1 (JYSK KONSTRUKTIONSTEKNIK A/S)

(D2) “BILWINCO tray dispensing systems”,

http://www. sismatec.n/merken/bilwinco/Toebehoren/Denester.pdf,

(D3) ISSUU-Packmarkedet 156, 2008, “Bakker frem . . . ”, by Jesper Kahr Nielsen,

http://issuu.com/jesperkahr/docs/packmarkedet okt 1 56 2008,

(D4) “BILWINCO A/S on Scanpack 2009, Stand no. 807:61”,

http://www.foodsupply.dk/announcement/view/4090/bilwinco_as_pa_sca npak_{—}2009

D1 describes a dispenser for individual dispensing of containers with an upper annular outer flange such as trays. The dispenser includes a tray dispenser cassette and a base station that can be connected to each other.

Documents D2-D4 describe a similar tray dispenser. It is mentioned (in D2) that this tray dispenser's tray dispenser cassette is made entirely of stainless steel components.

However, one drawback of the listed documents D1-D4 entails the fact that the tray dispenser construction, including the connections between the tray dispenser station and cassette, are inconvenient in practice, among other things due to hygiene reasons.

### SUMMARY OF THE INVENTION

It is therefore an object of the invention to provide a tray dispenser without the abovementioned disadvantages.

The object of the invention is achieved by a tray dispenser for dispensing of trays such as trays for packaging where the tray dispenser includes a tray dispenser cassette and a base station which can be placed on a stand. The tray dispenser cassette can be interconnected to the base station, the base station containing the electronic components. The tray dispenser cassette contains solely mechanical components made of materials that are corrosion resistant, and which can be cleaned by immersion in a cleaning liquid. The base station includes at least one motor which can operate the tray dispenser cassette via a mechanical connection.

In this way, it becomes possible to effectively clean the tray dispenser cassette, thereby minimizing the risk of bacterial contamination and contamination of the trays and the surroundings

Other preferred embodiments of the tray dispenser are described further below.

As mentioned, the invention also related to the application of the mentioned tray dispenser for trays used for food.

This makes it possible to use tray dispensers with minimized risk of bacterial contamination of food caused by the tray dispensers.

Additional appropriate applications are also described further below.

### BRIEF DESCRIPTION OF THE DRAWINGS

The invention will now be further explained with reference to the drawings, in which:

FIG. 1 shows a tray dispenser, which comprises a base that is mounted on a stand and which also comprises a tray dispenser cassette connected to the base station;

FIG. 2 shows a tray dispenser cassette;

FIG. 3 shows the same tray dispenser cassette as FIG. 2, but shown from a different perspective and where the tray dispenser cassette in FIG. 3 is fitted with trays;

FIG. 4 shows, in a section, a schematic diagram of the connection area between a base station and a tray dispenser cassette;

FIG. 5 shows a base station with a connected tray dispenser cassette and an open cassette cover;

FIG. 6 shows a schematic diagram of the tray dispenser with a base station and a detached tray dispenser cassette;

FIG. 7 shows a schematic diagram of the tray dispenser with a base station and a partially inserted tray dispenser cassette; and,

FIG. 8 shows a schematic diagram of the tray dispenser with a base station and a connected tray dispenser cassette.

### DETAILED DESCRIPTION OF THE INVENTION

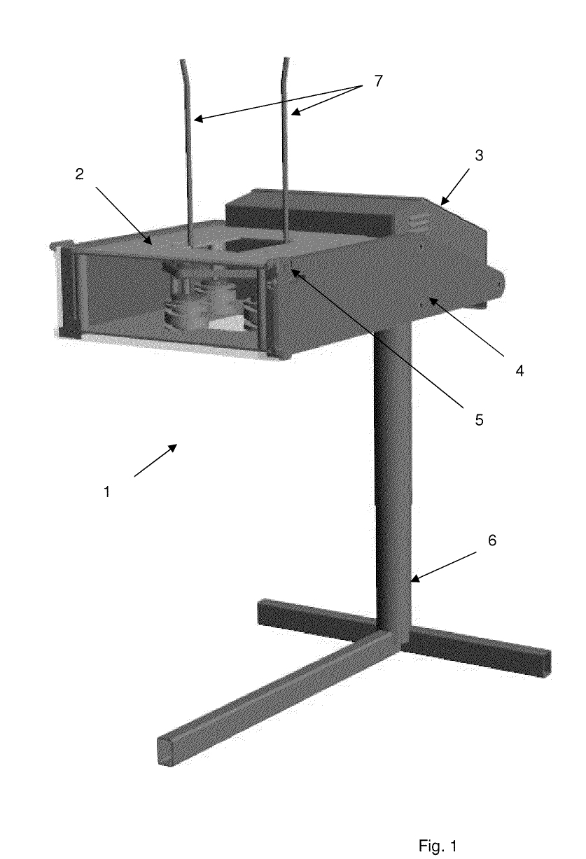

In FIG. 1 the number 1 designates a tray dispenser for dispensing trays such as packaging trays in which the tray dispenser comprises a tray dispenser cassette 2 and a base station 3, which, as shown, can be placed on a stand 6, and where the tray dispenser cassette 2 can be connected to the base station 3.

The tray dispenser cassette 2 is connected to the base station 3 guided by side plates 4 which are located on the base station 3.

FIG. 1 also shows that two draglinks 7 emanate from the tray dispenser cassette 2. These are intended to position the trays that should be dispensed by the tray dispenser.

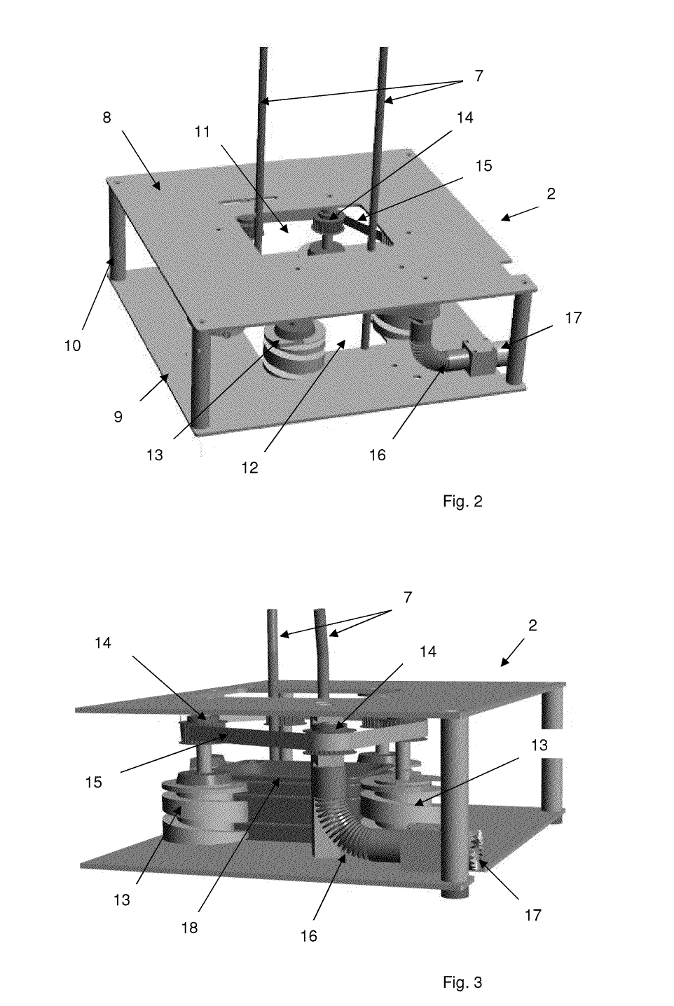

FIG. 2 shows a tray dispenser cassette 2 from a perspective that comprises a top plate 8 which is formed with a hole 11 for feeding the trays to be dispensed, and through which two draglinks 7 emanate.

The tray dispenser cassette 2 further comprises a bottom plate 9 which is formed with a hole 12 for the discharge of trays that are dispensed.

The top plate 8 and bottom plate 9 are connected via a joining link 10.

FIG. 2 and FIG. 3 also show that the tray dispenser cassette 2 is also provided with a number of dispenser augers 13, which are used for dispensing trays 18, which are added to the tray dispenser cassette 2 through the hole 11 and where the dispenser augers 13, through wheels such as sprocket wheels 14, are driven by a chain or belt including a toothed belt 15 that is controlled by a power transmission component such as a spring 16 which is connected to a shaft coupling 17, which for example can be fitted with a tooth or spline in the coupling surface.

In a preferred embodiment, the tray dispenser cassette 2 is fitted with preferably four tray dispenser augers 13 that are located in the corners of the trays 18 to be dispensed.

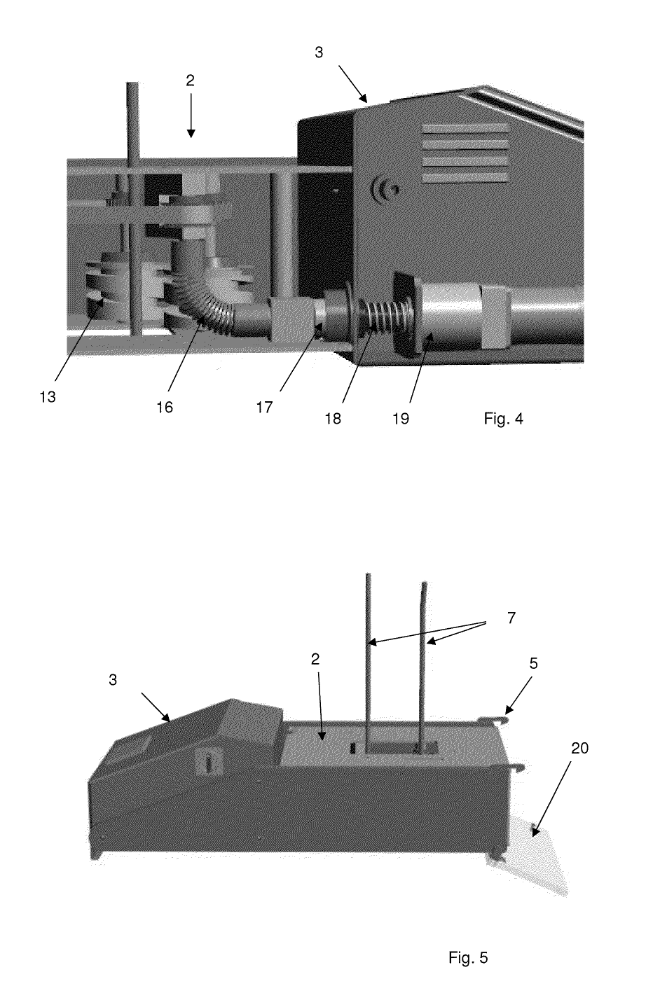

FIG. 4 shows in a section a schematic diagram of the connecting area between a base station 3 and a tray dispenser cassette 2, wherein the base station is fitted with a motor 19 whose pivot, via a mechanical connection 18, is in engagement with the shaft coupling 17 on the tray dispenser cassette 2.

In a preferred embodiment, the connection of the base station 3 and the tray dispenser cassette 2 is made without the use of tools with a so-called snap coupling mechanism that connects the opposing gear teeth or splines on the coupling surfaces resulting from axle couplers 17 and 18.

FIG. 5 shows a base station 3 with a connected tray dispenser cassette 2, and an open cassette cover 20 which can be closed and thus shield the tray dispenser cassette 2.

FIG. 6 to FIG. 8 show the three stages of how a base station 3 can be connected to a tray dispenser cassette 2.

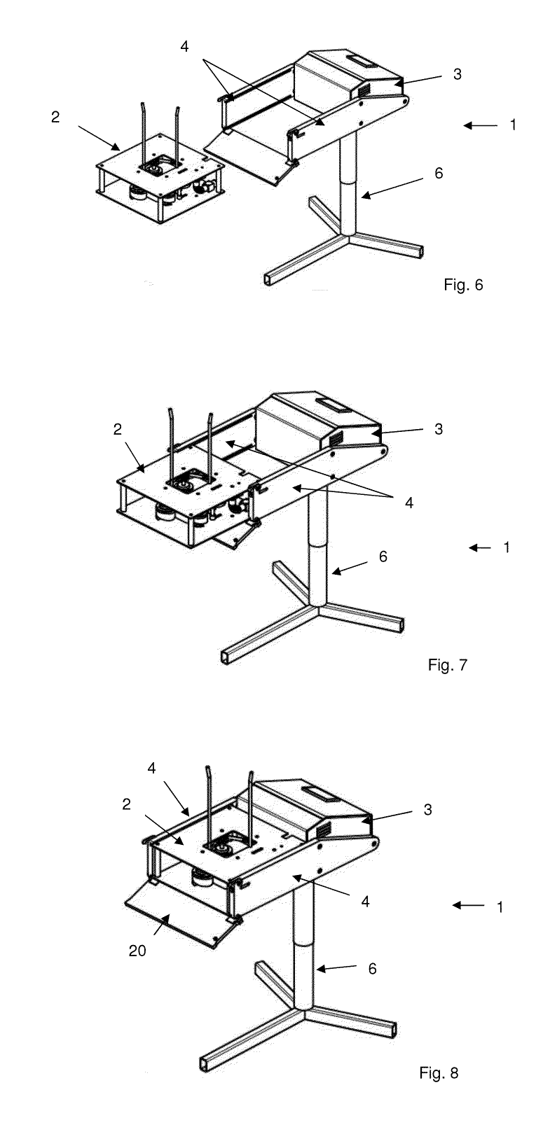

FIG. 6 shows that the tray dispenser cassette 2 is detached from the base station 3, while the tray dispenser cassette 2 in FIG. 7 is located between the side plates 4, which can be fitted with guide tracks or rails used for guiding the tray dispenser cassette 2.

FIG. 8 shows a base station 3, which is connected to a tray dispenser cassette 2 that can ultimately be shielded by closing the cassette cover 20 that can be locked with brackets 5, as shown in FIG. 1 and FIG. 5.

In a preferred embodiment, it is also characteristic for the invention that the weight of tray dispenser cassette 2 is less than or equal to 11 kg. This means that a person is allowed to replace a tray dispenser cassette on his own in accordance with modern health and safety legislation.

Another special feature of the invention is the fact that the base station's 3 motor 19 is an electric servomotor, which provides the possibility of high precision, fast tray dispensing as well as low energy consumption and a low noise level.

In addition, the base station can be hermetically sealed such that its interior does not come into contact with trays to be dispensed or e.g. the foods that must be filled into the dispensed trays.

In a preferred embodiment, the tray dispenser 1 can, for safety reasons, be designed in such a way that the tray dispenser cassette 2 will start by being engaged mechanically with the base station 3 via the coupling 18, and thus can only be activated when the cassette cover 20 is closed. Once the cassette cover 20 is closed, the entire tray dispenser cassette 2 is enclosed by cover plates.

As mentioned, the invention includes the application of a tray dispenser 1 for trays 18 that are used for food.

In addition to this, the invention includes the application of the tray dispenser 1 at food processing plants including abattoirs.

1-8. (canceled)

9. A tray dispenser for dispensing trays for packaging, the tray dispenser comprising:
a tray dispenser cassette;
a base station adapted for being placed on a stand;
the tray dispenser cassette being interconnectable to the base station;
wherein the base station contains electronic components for operating the tray dispenser, the tray dispenser cassette containing solely mechanical components made of materials that are corrosion resistant, the tray dispenser cassette being adapted for being cleaned by immersion in a cleaning liquid; and,
wherein the base station contains at least one motor for operating the tray dispenser cassette via a mechanical connection.

10. The tray dispenser according to claim 9, wherein the mechanical connection is engaged without the use of tools.

11. The tray dispenser according to claim 9, wherein the tray dispenser cassette is guided by side plates located on the base station into mechanically connecting to the base station.

12. The tray dispenser according to claim 9, further comprising a cassette cover for shielding the tray dispenser cassette after being mechanically connected to a base station, the cassette cover located on the base station.

13. The tray dispenser according to claim 9, wherein the tray dispenser cassette has a shaft operated by the base station via a coupling, a power transmission component provided for transferring energy from the base station motor to a plurality of tray dispenser augers for dispensing trays.

14. The tray dispenser according to claim 13, wherein the power transmission component is selected from the group consisting of a spring, a chain, a belt or a toothed belt.

15. The tray dispenser according to claim 13, wherein the plurality of tray dispenser augers comprises four tray dispenser augers.

16. The tray dispenser according to claim 9, wherein the tray dispenser cassette has a weight which is less than or equal to 11 kg.

17. The tray dispenser according to claim 9, wherein the base station motor is an electric servomotor.
